(19) United States
(12) Patent Application Publication
(10) Pub. No.: US 2003/0146903 A1
(43) Pub. Date: Aug. 7, 2003

(54) Wired keyboard with built-in web camera

(76) Inventor: Leland Yi, Seoul (KR)

Correspondence Address: WEISS & MOY PC, 4204 NORTH BROWN AVENUE, SCOTTSDALE, AZ, 85251, US

(21) Appl. No.: 10/060,994

(22) Filed: Feb. 1, 2002

(51) Int. Cl. G09G 5/00

(52) U.S. Cl. 345/168

(57) ABSTRACT

A wired keyboard with a built-in web camera, which eliminates the need of a separate web camera for image data transmission and which has an improved input key performance. According to one preferred embodiment, a wired keyboard with a built-in web camera includes a plurality of input keys and comprises: a first input part for producing a code corresponding to an input key selected by a user, generating input key data corresponding to the code, and transmitting the input key data; a second input part for receiving image data, converting the image data into a digital image signal, and transmitting the digital image signal; an integrated processing part for receiving the input key data and/or the converted image data, assigning a predetermined identification code to the data, and converting the identification-coded data into a predetermined data format; and a transmitter for transmitting the data converted by the integrated processing part to a terminal device.

### BACKGROUND OF THE INVENTION

1. Field of the Invention

The present invention relates generally to computer keyboards and, more specifically, to a wired keyboard with a built-in web camera that eliminates the need of a separate web camera for image data transmission and that has an improved input key performance.

2. Description of Prior Art

Along with the development of technology, computers are utilized for many purposes, including exchange of specific information between people, or purchasing specific goods. Although there are different types of computers that are manufactured by a variety of companies, all computers have input devices, output devices, and processing devices in common. Hereinafter, a conventional keyboard will be described using an accompanying drawing. Since this description is useful to easily understand the present invention, the conventional keyboard will be described in detail.

FIG. 1 is a perspective view of the conventional keyboard. Referring to FIG. 1, the conventional keyboard comprises a plurality of input keys. When a user selects a specific input key, the keyboard detects an electrical response signal corresponding to the specific input key and processes the input key data selection corresponding to the electrical response signal. Also, each input key of the keyboard has a specific operation assigned. Furthermore, the keyboard comprises microprocessors to control digital signals.

Methods for transferring a data selection corresponding to the specific input key selected by the user include the mechanical method and the membranes method. The recognition process of the data selection corresponding to the specific input key using those methods is described in brief.

When the user selects a specific input key, the internal circuit for transferring a corresponding digital signal to a microprocessor and the signal transferring process are almost the same for the above methods. However, the main difference between the methods is how the electrodes, which generate the signal, are contacted.

The mechanical method utilizes a mechanical principle. That is, when a key is pressed, a point of contact is moved down to activate a micro-switch to generate a digital signal before being returned to its original position by a spring. Accordingly, if there is a sound such as a “click” when the user presses a specific key, the mechanical method is used in this keyboard.

If the membranes method is used in the keyboard, then there is a space between the point of contact of the input key and the key plate, with the membrane placed on the key plate. By pressing a specific input key, a membrane is selected and, due to the resilience of the membrane, contact between the membrane and the contacting sheet is reached to generate a digital signal.

When a user selects a specific input key from a plurality of input keys, the method to determine which input key is selected is as follows:

Alphanumeric input keys, such as 1, 2, a, b, @, %, are in four rows and four response circuits are located below the rows of the input keys. The aforementioned response circuit examines more than one thousand times per one second whether or not a signal is inputted. When the user selects a specific input key, the response circuit detects a row signal first and then a column signal corresponding to the row signal. The maximum number of columns is 15 and the response circuit associates the intersection signal with a specific input key.

Accordingly, when the user selects an input key, the signal generated by the input key does not have a special meaning. Whether the generated signal will be used for merely output, for calculation or as a control code is depending on a control program that controls the keyboard. Accordingly, in order to make unambiguous use of the aforementioned codes, ASCII was defined as a standard key code that is used in computers. Therefore, all signals generated in computers are processed on the ground of the value assigned by the program according to ASCII.

When the user selects a specific input key, a code corresponding to the selected input key is transferred to a ‘keyboard controller’. The keyboard controller is located in the keyboard as a form of electrical circuit or on the motherboard. The transferred code is stored in a ‘keyboard buffer’. As a kind of memory, the keyboard buffer is comprised of RAM and temporarily stores necessary data whenever needed. The reason for storing data one by one is that a specific task can't be directly processed by the use of a signal from an input key.

Hereinafter, the procedure of processing the code will be described with two cases in which the user selects ‘a’ or ‘A’. From the view of the user, selecting ‘a’ or ‘A’ is not very different. When the user selects ‘a’, he just pushes the ‘a’ input key. But when the user selects ‘A’, he has to push the ‘a’ together with the shift input key. Accordingly, whenever the keyboard controller receives a code corresponding to ‘a’, then the keyboard controller checks the keyboard buffer to find if there is a code corresponding to any input key that can be selected with the ‘a’ input key, such as the shift input key. However, the processed code is not converted into a scan code directly. A predetermined interrupt request (IRQ) determines whether the processed code is a control code or a mere character code. The predetermined IRQ is fixed by the programmer and cannot be selected or changed by the user. When an interrupt is generated, the scan code is converted into ASCII code and stored in the memory. The scan code represents a value that is transferred from an input key to the keyboard controller and the ASCII code represents a final value that determines whether the scan code is a character code or a control code and is converted into a value for internal processing of the computer. The input data that is processed in the aforementioned steps is utilized in a proper way according to the purpose of the case.

In multimedia, the most fundamental task is to combine computers, electric home appliances, and communication devices by means of digitalized information. The computer is excellent at editing, storage, and processing of digitalized information, but is weak in processing analog sound and image. Accordingly, multimedia is developed mainly to make full use of the advantages of computers and electric home appliances and to make up for the weak points of each of them.

Hereinafter, a web camera, as a video camera for video conferencing or chatting, which can interface directly with a computer via a USB (Universal Serial Bus) port without video capture board and which can process the inputted image according to the USB interface protocol, is described in brief. A conventional web camera comprises a lens for collecting light reflected from the object, a ccd for converting the light into a charge to be stored temporarily and to produce an electrical signal, an analog-digital converter for converting the electrical signal into a digital signal, an image compensator for converting the data size of the digital signal to a predetermined data size having a reduced resolution, and an interface for converting the digital signal according to the USB protocol and for transmitting the digital signal to the computer.

However, a user who wants to use a conventional keyboard and a web camera together has to install them individually, so there is an inconvenience of occupying large space. Further, because a conventional keyboard and a web camera are connected to the computer via wired connection, a user who wants to use them together has the inconvenience that he or she cannot perform a task at the place where he or she wants to. Further, a conventional keyboard determines which input key is selected by the use of a signal from the intersection of row and column, which corresponds to the input key. If one input key is pushed, another input key cannot be read simultaneously.

### SUMMARY OF THE INVENTION

Accordingly, an object of the present invention is to provide a wired keyboard with a built-in web camera, wherein the keyboard and the web camera are integrated to help the user to efficiently utilize the working space, wherein the web camera can be stored in the keyboard to protect the lens while the web camera is not used, and wherein the web camera can be detached from the keyboard for use in another place of the user's choice.

Another object of the present invention is to provide a wired keyboard with a built-in web camera, which comprises an IC chip to produce specific codes corresponding to each input key of the keyboard, so that a task can be perfectly processed even in the case, that the user pushes another input key simultaneously.

### BRIEF DESCRIPTION OF THE PREFERRED EMBODIMENTS

In accordance with one embodiment of the present invention, a wired keyboard with a built-in web camera is disclosed. The wired keyboard with the built-in web camera, which includes a plurality of input keys, comprises, in combination: a first input part for producing a code corresponding to an input key selected by a user, generating input key data corresponding to the code, and transmitting the input key data; a second input part for receiving image data, converting the image data into a digital image signal, and transmitting the digital image signal; an integrated processing part for receiving the input key data and/or the converted image data, assigning a predetermined identification code to the data, and converting the identification-coded data into a predetermined data format; and a transmitter for transmitting the data converted by the integrated processing part to a terminal device.

In accordance with another preferred embodiment of the present invention, a wired keyboard with a built-in web camera, which is coupled to a computer to receive an input from a user is disclosed, comprising, in combination: an input key signal generator for producing and transmitting a predetermined data code corresponding to an input key selected by a user, wherein the input key signal generator includes a device generating the predetermined code data corresponding to each input key; and an input key data generator for producing input key data corresponding to the data code, wherein the input key signal generator transmits the data code through at least one route, and the input key data generator can discriminate a valid data code from an invalid code data.

In accordance with another preferred embodiment of the present invention, an integrated processing part of a wired keyboard including an input key part and a web camera part is disclosed, comprising, in combination: a receiver for receiving input key data inputted from the key input part and/or image data inputted from the web camera part; an identification code generator for producing and assigning a predetermined identification code to the received data; and a converter for converting and transmitting the identification-coded data into a predetermined data format.

### BRIEF DESCRIPTION OF DRAWINGS

FIG. 1 is a perspective view of a conventional keyboard.

FIG. 2 is a block diagram of a wired keyboard with a built-in web camera in accordance with one preferred embodiment of the present invention.

FIG. 3 is a block diagram of a first input part according to the present invention.

FIG. 4 is a perspective view of the wired keyboard with the built-in web camera according to the present invention.

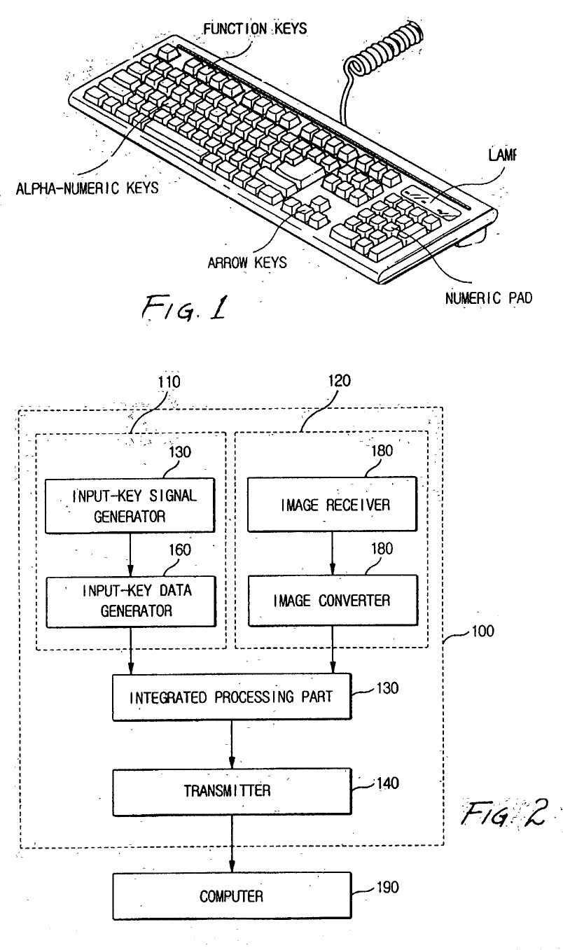

### DETAILED DESCRIPTION OF THE PREFERRED EMBODIMENTS

Hereinafter the preferred embodiments of the present invention will be described with the accompanying drawings.

Referring to FIG. 2, a block diagram of a wired keyboard with a built-in web camera 100 according to the present invention is shown. The wired keyboard with the built-in web camera 100 generally comprises a first input part 110, a second input part 120, an integrated processing part 130 and a transmitter 140. The first input part 110 for receiving specific user selected input key data generally comprises an input key signal generator 150 and an input key data generator 160. The first input part 110 will be described in detail in FIG. 3. The second input part 120 for receiving image data inputted from the web camera generally comprises an image receiver 170 and an image converter 180.

The wired keyboard with the built-in web camera 100 also includes a plurality of input keys comprising an IC chip (e.g., bit code IC) that can produce an individual code corresponding to a specific input key selected by a user. Accordingly, if the user selects a specific input key, the input key signal generator 150 produces a predetermined code using the IC chip. Based on the information of the predetermined code, the input key data generator 160 determines which input key was selected by the user. The determined input key data are then transferred to the integrated processing part 130.

In one preferred embodiment, the first input part 110 further comprises an additional memory (e.g., buffer) for storing a predetermined amount of input key data. While storing a certain amount of input key data inputted from the input key data generator 160, the memory can transmit a certain amount of input key data to the integrated processing part 130. This process can be executed so fast that the user cannot recognize a time-delay between storing and transmission.

Still referring to FIG. 2, in the case that the user operates the second input part 120 for video chatting or video conferencing, the image receiver 170 receives corresponding image data and then transmits the image data to the image converter 180. The image converter 180 then converts the image data into electrical signals, or the image data in form of analog signals into image data in the form of digital signals, and then transmits the converted image data to the integrated processing part 130.

In another preferred embodiment, the second input part 120 further comprises an image controller for adjusting the brightness and the colors of the inputted image data in order to improve the quality and an image compressor for compressing the image data. The image controller adjusts the brightness and the colors of the image data using a reference value extracted from the analysis of the image signal. The reference value is obtained from a histogram of brightness values of the entire image signal and by extracting several peak values. The brightness of the colors included in the image signal is processed by each color; however, standard adjustment of the entire brightness can be applied without change. Therefore, the brightness of the image will be adjusted so that it is entirely improved and has a clear outline. The image controller also adjusts the contrast. The adjusted image is then compressed in the image compressor to a predetermined data format (e.g., jpeg, mpeg).

Still referring to FIG. 2, the input key data inputted from the first input part 110 and the image data inputted from the second input part 120 are transmitted to the integrated processing part 130. The integrated processing part 130 assigns a predetermined identification code to the data, converts the data into a predetermined data format (e.g., USB protocol), and then transmits the data to the transmitter 140. The integrated processing part 130 is also coupled to an external connection port for data transmission to and from at least one external USB device.

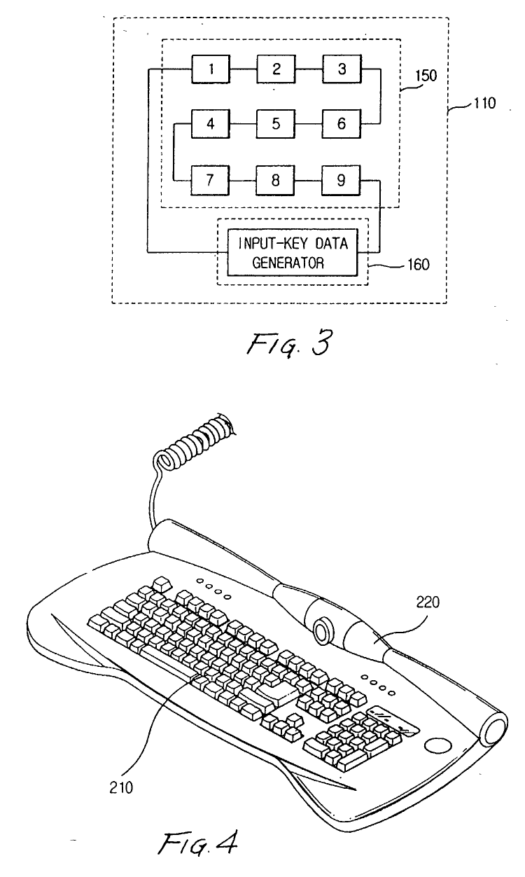

The transmitter 140 transmits the received data to the computer 190 via USB cable. The input key data and the image data can be transmitted via a single USB cable since each kind of data has a specific identification code or via separated USB cables. The transmitter 140 generally comprises a USB hub and therefore, the input key part 210 (shown in FIG. 4) and the web camera part 220 (shown in FIG. 4) are recognized as separated devices. A hub is a device for connecting several ports to one port. In the case of using a hub obeying the USB transmission protocol, the hub can connect a maximum of 127 devices. The web camera part 220 can be further controlled by an additional device driver.

Referring now to FIG. 3, a block diagram of the first input part 110 according to the present invention is shown. The first input part 110 generally comprises the input key signal generator 150 and the input key data generator 160. In one preferred embodiment, the first input part 110 is a keyboard comprising several input keys.

An integrated circuit IC controls the processes in the input key signal generator 150, as shown in FIG. 3. The IC produces a bit code corresponding to each input key, for example, the bit code ‘10101’ is produced for the input key ‘1’ and the bit code ‘10111’ is produced for the input key ‘2’. If the user selects input key ‘1’, the bit code ‘10101’ is produced by the IC. The produced bit code is then transferred through a recognition line on either side (as shown in FIG. 3) to the input key data generator 160. The input key data generator 160 recognizes the selected input key via the use of the bit code. Since the bit code produced by the input key signal generator 150 is transferred through the recognition line on either side, the input key data generator 160 will receive the same bit code twice. However, only the first-arrived bit code is recognized as a valid bit code and the last-arrived bit code is recognized as an invalid bit code to be deleted. The input key data generator 160 produces the input key data corresponding to the valid bit code and then transmits the input key data to the integrated processing part 130 (shown in FIG. 2).

Referring now to FIG. 4, a perspective view of the wired keyboard with the built-in web camera according to the present invention is shown. The wired keyboard with the built-in web camera generally comprises an input key part 210 and a web camera part 220. The input key part 210 comprises a plurality of input keys, so the user can input specific characters or symbols. The web camera part 220 is an input device for image signals that can be used for video chatting or video conferencing. The lens included in the web camera part 220 can be controlled in an up, down, right, and left direction. Furthermore, the web camera part 220 can be stored in the keyboard to protect the lens while the web camera is not used. The web camera part 220 can also be detached from the keyboard. This way the user can move the web camera part 220 to a convenient place of his choice. As aforementioned, the input key part 210 and the web camera part 220 are implemented as separate devices, so each can operate as an independent device after being recognized.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A wired keyboard with a built-in web camera, which includes a plurality of input keys, comprising, in combination:
a first input part for producing a code corresponding to an input key selected by a user, generating input key data corresponding to said code, and transmitting said input key data;
a second input part for receiving image data, converting said image data into a digital image signal, and transmitting said digital image signal;
an integrated processing part for receiving data, wherein said data comprise at least one selected from a group consisting of said input key data and said converted image data, assigning a predetermined identification code to said data, and converting said identification-coded data into a predetermined data format; and
a transmitter for transmitting said data converted by said integrated processing part to a terminal device.

2. The wired keyboard as stated in claim 1, wherein said second input part can be separated from said wired keyboard.

3. The wired keyboard as stated in claim 1, wherein said first input part comprises, in combination:
an input key signal generator for producing said code corresponding to an input key selected by said user; and
an input key data generator for producing said input key data corresponding to said code.

4. The wired keyboard as stated in claim 1, wherein said second input part comprises, in combination:
an image receiver for receiving said image data; and
an image converter for converting and transmitting said image data into said digital image data.

5. The wired keyboard as stated in claim 4, wherein said image receiver includes a lens, which can be controlled in an up, down, right and left direction.

6. The wired keyboard as stated in claim 1, wherein said first input part further comprises a first memory for storing a predetermined amount of said input key data for a predetermined time period.

7. The wired keyboard as stated in claim 1, wherein said second input part further comprises a second memory for storing a predetermined amount of said image data converted by said integrated processing part for a predetermined time.

8. A wired keyboard with a built-in web camera, which is coupled to a computer to receive an input from said user, comprising, in combination:
an input key signal generator for producing and transmitting a predetermined data code corresponding to an input key selected by said user,
wherein said input key signal generator includes a device generating said predetermined code data corresponding to each input key; and
an input key data generator for producing an input key data corresponding to said data code,
wherein said input key signal generator transmits said data code through at least one route and said input key data generator can discriminate a valid data code from an invalid data code.

9. An integrated processing part of a wired keyboard including an input key part and a web camera part comprising, in combination:
a receiver for receiving data, wherein said data comprise at least one selected from a group consisting of input key data inputted from said input key part and image data inputted from said web camera part;
an identification code generator for producing and assigning a predetermined identification code to said received data; and
a converter for converting and transmitting said identification-coded data into a predetermined data format.
